(19) United States
(12) Patent Application Publication
(10) Pub. No.: US 2022/0067555 A1
(43) Pub. Date: Mar. 3, 2022

(54) Creation Assisting Device, Creation Assisting Method, And Recording Medium

(71) Applicant: Hitachi, Ltd., Tokyo (JP)

(72) Inventors: Misa SATO, Tokyo (JP); Kohsuke YANAI, Tokyo (JP)

(21) Appl. No.: 17/370,672

(22) Filed: Jul. 8, 2021

(30) Foreign Application Priority Data
Aug. 28, 2020 (JP) 2020-144124

(51) Int. Cl. G06N 5/04; G06N 5/02; G06F 40/289

(52) U.S. Cl. CPC G06N 5/041; G06F 40/289; G06N 5/022

(57) ABSTRACT

To attempt to enhance the scenario creation efficiency. A creation assisting device can access a database storing a set of relational knowledge data including two nodes defining knowledge, and an edge defining a relationship between the nodes, and linking the nodes, acquires an inference route defining an order of pieces of knowledge forming a hypothesis, updates a scenario embodying the hypothesis if a second node corresponding to a first node in an inference route is added to the scenario, generates a first search query for searching for a second destination node from the second node, on a basis of the first node in the inference route, a first destination node from the first node, and a first edge linking the first node, and the first destination node, searches the database for particular first relational knowledge data corresponding to the first search query, and outputs the particular first relational knowledge data.

### CLAIM OF PRIORITY

The present application claims priority from Japanese patent application JP 2020-144124 filed on Aug. 28, 2020, the content of which is hereby incorporated by reference into this application.

### BACKGROUND

The present invention relates to a creation assisting device, a creation assisting method, and a recording medium.

Japanese Unexamined Patent Application Publication No. 2015-121897 discloses a scenario generating device that collects elements to be a basis for generation of a social scenario useful for balanced, appropriate decision-making by people. The scenario generating device includes: a causal-relationship phrase-pair DB that stores causal-relationship phrase pairs; a synonymous relationship generating section that searches for a causal-relationship phrase pair that has a causal phrase having a causal consistency with a result phrase of each of the causal-relationship phrase pairs, and generates linkage information of the causal-relationship phrase pairs; a linkage relationship DB that stores the linkage information; and a causal-relationship linking section that uses the linkage information to interlink a result phrase of a causal-relationship phrase pair with a causal-relationship phrase pair having a causal phrase having a causal consistency with the result phrase to thereby interlink the causal relationships.

### SUMMARY

However, the scenario generating device according to Japanese Unexamined Patent Application Publication No. 2015-121897 mentioned above cannot specify a relationship between pieces of knowledge, and conditions of an end point, and intermediate points of a scenario. Accordingly, there is a problem that many scenarios other than desired scenarios are generated undesirably. In addition, the same applies not only to generation of social scenarios aimed for decision-making like the one mentioned above, but also to generation of diverse scenarios such as hypothetical scenarios in technological development, or causal scenarios of malfunction events.

An object of the present invention is to attempt to enhance the efficiency of scenario creation.

A creation assisting device according to one side surface of the invention disclosed in the present application is a creation assisting device including a processor that executes a program, and a storage device that stores the program. The creation assisting device can access a database that stores a set of relational knowledge data including two nodes defining knowledge, and an edge that defines a relationship between the two nodes, and links the two nodes. The processor executes: an acquisition process of acquiring an inference route that defines an order of a plurality of pieces of knowledge that form a hypothesis; an updating process of updating a scenario that embodies the hypothesis in a case that a second node corresponding to a first node in an inference route acquired in the acquisition process is added to the scenario; a generation process of generating a first search query for searching for a second destination node from the second node, on a basis of the first node in the inference route, a first destination node from the first node, and a first edge that links the first node, and the first destination node; a search process of searching the database for particular first relational knowledge data corresponding to the first search query generated in the generation process; and an output process of outputting the particular first relational knowledge data found through the search in the search process.

According to representative embodiments of the present invention, it is possible to attempt to enhance the efficiency of scenario creation. Problems, configurations, and advantages other than those mentioned before are clarified by the following explanation of embodiments.

### BRIEF DESCRIPTION OF THE DRAWINGS

FIG. 1 is an explanatory diagram illustrating an example system configuration of a creation assisting system.

FIG. 2 is a block diagram illustrating an example hardware configuration of a computer.

FIG. 3 is an explanatory diagram illustrating example scenario generation performed by using the creation assisting device.

FIG. 4 is an explanatory diagram illustrating one example of a relational knowledge DB illustrated in FIG. 1.

FIG. 5 is an explanatory diagram illustrating an example structure of a search query.

FIG. 6 is a flowchart illustrating an example scenario-creation-assisting-process procedure performed by the creation assisting device.

FIG. 7 is flowchart illustrating a detailed example process procedure of a search process (Step S610) illustrated in FIG. 6.

FIG. 8 is an explanatory diagram illustrating example phrase extraction illustrated in Steps S706 to S710 in FIG. 7.

FIG. 9 is an explanatory diagram illustrating example scenario creation 1 performed in accordance with user operation.

FIG. 10 is an explanatory diagram illustrating example scenario creation 2 performed in accordance with user operation.

FIG. 11 is an explanatory diagram illustrating example scenario creation 3 performed in accordance with user operation.

FIG. 12 is an explanatory diagram illustrating example scenario creation 4 performed in accordance with user operation.

FIG. 13 is an explanatory diagram illustrating example scenario creation 5 performed in accordance with user operation.

FIG. 14 is an explanatory diagram illustrating example scenario creation 6 performed in accordance with user operation.

FIG. 15 is an explanatory diagram illustrating example scenario creation 7 performed in accordance with user operation.

FIG. 16 is an explanatory diagram illustrating example scenario creation 8 performed in accordance with user operation.

FIG. 17 is an explanatory diagram illustrating example scenario creation 9 performed in accordance with user operation.

FIG. 18 is an explanatory diagram illustrating example scenario creation 10 performed in accordance with user operation.

FIG. 19 is an explanatory diagram illustrating example scenario creation 11 performed in accordance with user operation.

FIG. 20 is an explanatory diagram illustrating example scenario creation 12 performed in accordance with user operation.

### DETAILED DESCRIPTION

In the following, scenario creation assistance according to the present embodiments is explained. Note that phrases are strings each of which includes a series of words, and represents one collective meaning, but one word also is treated as a phrase in the present embodiments.

### <Example Creation Assisting System Configuration>

FIG. 1 is an explanatory diagram illustrating an example system configuration of a creation assisting system. A creation assisting system 100 has a server 101, and terminals 102. The server 101, and the terminals 102 are connected communicatively via a network 103 such as the Internet, a LAN (Local Area Network) or a WAN (Wide Area Network) such that they can communicate with each other.

The server 101 is a computer that assists scenario generation. The server 101 has a relational knowledge database (DB) 104. The relational knowledge DB 104 is a database including information that is obtained in advance by relational extraction from a document group, and by schema transform from an existing knowledge DB group. The relational knowledge DB 104 may include a link as information about access to an existing knowledge DB such as the Unified Medical Language System (Unified Medical Language System: UMLS). The relational knowledge DB 104 may be in a computer that can communicate with the server 101 via the network 103. The terminals 102 are computers that input data to the server 101, and receive outputs of data from the server 101. Specifically, for example, the terminals 102 remotely input data to the server 101 in accordance with user operation, display data from the server 101, and so on. Note that although the client-server-type creation assisting system 100 is explained with reference to FIG. 1, the creation assisting system 100 may be a standalone-type creation assisting system 100.

### <Hardware Configuration of Computer>

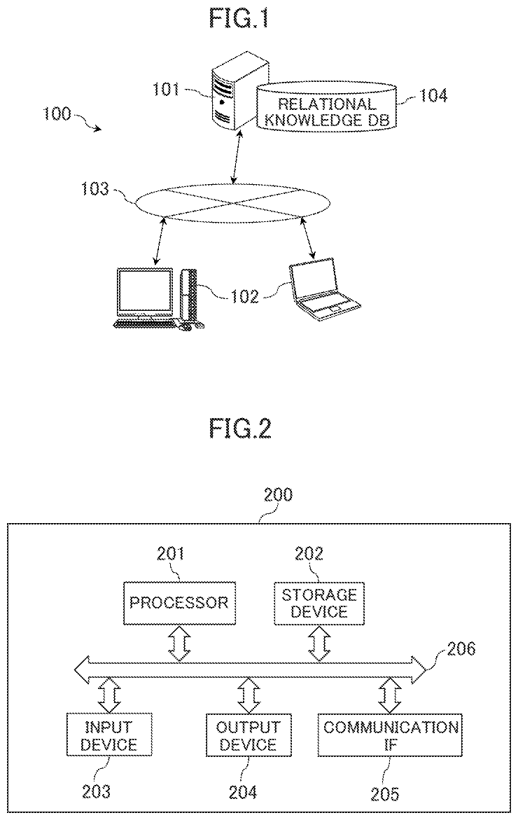

FIG. 2 is a block diagram illustrating an example hardware configuration of a computer. A computer 200 has a processor 201, a storage device 202, an input device 203, an output device 204, and a communication interface (communication IF) 205. The processor 201, the storage device 202, the input device 203, the output device 204, and the communication IF 205 are connected by a bus 206. The processor 201 controls the computer 200. The storage device 202 is a work area of the processor 201. In addition, the storage device 202 is a non-transitory or transitory recording medium that stores various types of program, and data. Examples of the storage device 202 include, for example, a ROM (Read Only Memory), a RAM (Random Access Memory), an HDD (Hard Disk Drive), and a flash memory. The input device 203 is used to input data. Examples of the input device 203 include, for example, a keyboard, a mouse, a touch panel, a ten-key, and a scanner. The output device 204 is used to output data. Examples of the output device 204 include, for example, a display, a printer, and a speaker. The communication IF 205 is connected with the network 103, and transmits, and receives data.

<Example Scenario Creation Assistance>

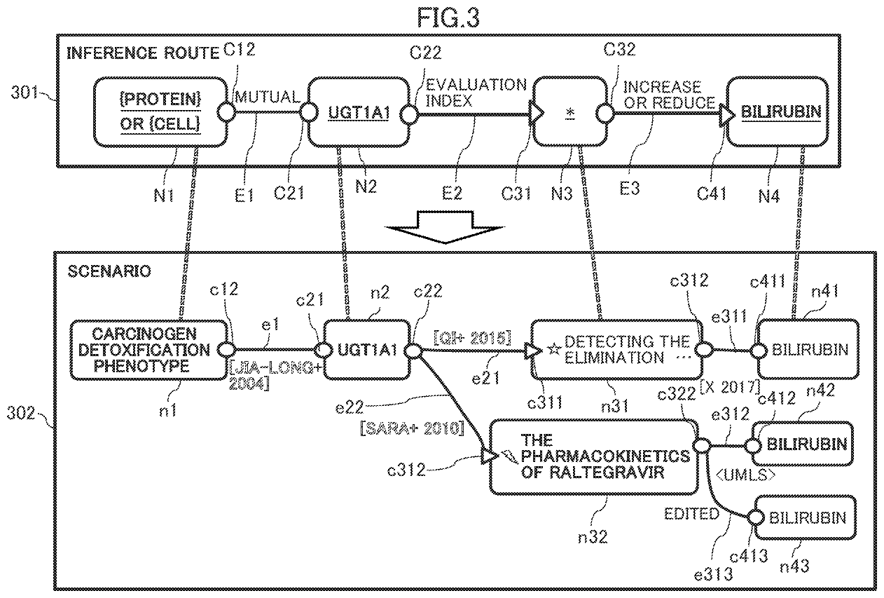

FIG. 3 is an explanatory diagram illustrating example scenario generation performed by using the server 101. The server 101 prompts a user to design an inference route 301, and prompts the user to generate a scenario 302 by using the inference route 301. The inference route 301 means a hypothesis, that is, an order of formation of unknown information predicted on the basis of known information. The scenario 302 means a new piece of knowledge in which a plurality of pieces of knowledge acquired from a plurality of data sources are linked in accordance with the hypothesis, that is, the inference route 301.

The inference route 301 has a node group including two or more nodes, and an edge group including one or more edges connecting the nodes. In the example of FIG. 3, the node group includes nodes N1 to N4 (denoted simply as nodes N when distinctions are not made therebetween), and the edge group includes edges E1 to E3 (denoted simply as edges E when distinctions are not made therebetween). Circular figures or triangular figures at both ends of the edges E are connection points C12, C21, C31, C32, and C41 (denoted simply as connection points C when distinctions are not made therebetween) that are connected with the nodes N. The edge E1 connects the nodes N1, and N2 at the connection points C12, and C21, the edge E2 connects the nodes N2, and N3 at the connection points C22, and C31, and the edge E3 connects the nodes N3, and N4 at the connection points C32, and C41.

The nodes N include strings input by a user. The strings are defined as concept classes or phrases. Strings in curly braces {} are concept classes, and strings not in curly braces {} are phrases. The concept classes represent superordinate concepts of the phrases. The phrases are specific examples of the concept classes. Note that “*” represents that neither a concept class nor a phrase is specified.

For each edge E, relationship data representing the relationship between nodes N at both ends of the edge E is defined. For example, “mutual” is defined for the edge E1, “evaluation index” is defined for the edge E2, and “increase or reduce” is defined for the edge E3. The shapes of the connection points C define the directions of the edges E. A connection point C (e.g. the connection point C31) having a triangle with one vertex positioned inside a node N defines a direction from the corresponding edge E (the edge E2 in this case) to the node N (the node N3 in this case) . A connection point C having a triangle with two vertices positioned inside a node N defines a direction from the node N to the corresponding edge E. Connection points C with circular figures do not specify directions.

Similarly to the inference route 301, the scenario 302 also has a node group including two or more nodes, and an edge group including one or more edges connecting the nodes N. In order to make a distinction between the inference route 301, and the scenario 302, nodes, edges, and connection points are denoted as nodes n (n1, n2, n31, n32, n41, n42, n43), edges e (e11, e21, e22, e312, e312, e313), and connection points c (c12, c21, c22, c311, c312, c411, c412, c413) in the scenario 302. The nodes n, the edges e, and the connection points c are created as duplicates of the inference route 301 or a search result of a search query (mentioned below with reference to FIG. 5) in accordance with user operation.

Specifically, for example, a node n in the scenario 302 is created as a duplicate of a node N of the inference route 301 in accordance with user operation. In this case, the original node N, and the duplicate node n are associated with each other. In addition, as mentioned below, a node n in the scenario 302 can be created as a duplicate of a search result in accordance with user operation. In a case that a node n is created as a duplicate of a search result, the duplicate node n, and a node N in the inference route 301 corresponding to the node n are associated with each other. In the scenario 302, nodes n can be linked by an edge e in accordance with user operation. An edge e, and an edge E in the inference route 301 corresponding to the edge e are associated with each other.

### <Relational Knowledge DB 104>

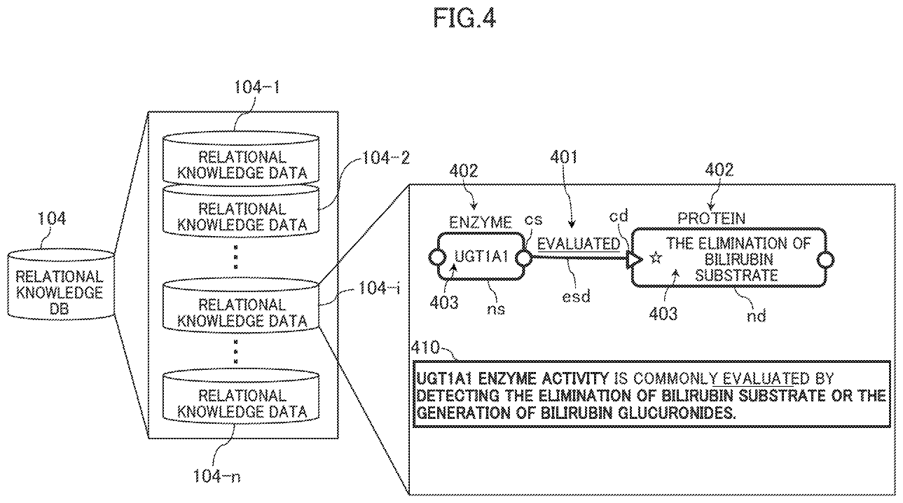

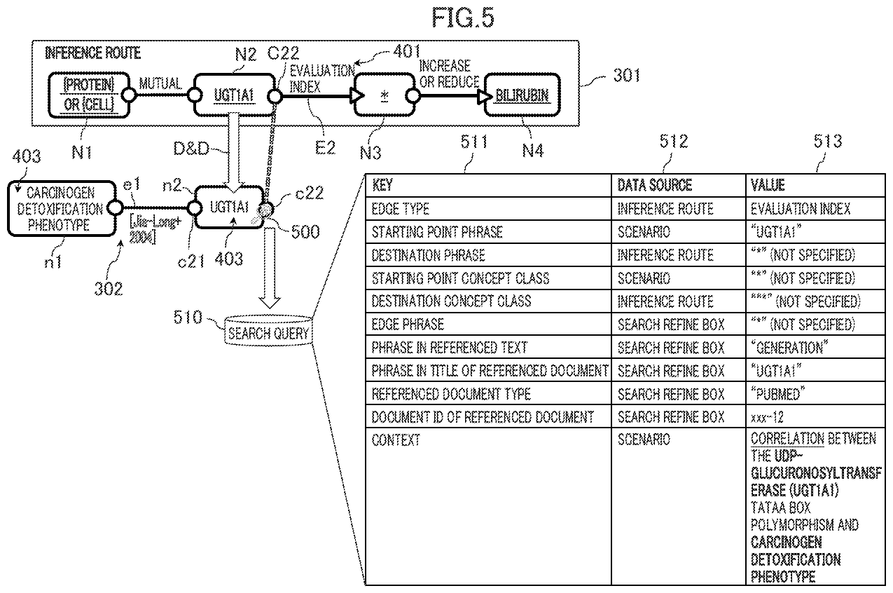

FIG. 4 is an explanatory diagram illustrating one example of the relational knowledge DB 104 illustrated in FIG. 1. The relational knowledge DB 104 stores n pieces of relational knowledge data 104-1 to K104-n (n is an integer equal to or larger than 1), for example. Relational knowledge data 104-i (i is an integer satisfying 1≤i≤n) includes one edge esd, and two nodes ns, and nd connected by both ends of the edge esd. The relational knowledge data 104-i may also include a reference text 410.

The edge esd has relationship data 401 (in this example, evaluated (meaning an evaluation index)). Each of the nodes ns, and nd has a concept class 402, and a phrase 403. In addition, each of the nodes ns, and nd has connection points c at its both ends. Here, connection points c at both ends of the edge e are denoted as connection points cs, and cd.

The reference text 410 is a string included in sentences in a referenced document as the ground of the relational knowledge data 104-i. The phrases 403 in the nodes ns, and nd, and the relationship data 401 of the edge esd are included in the reference text 410.

### <Structure of Search Query>

FIG. 5 is an explanatory diagram illustrating an example structure of a search query. Triggered by user operation by using the input device 203 of a terminal 102, a search query 510 is generated by the server 101 or the terminal 102. It is supposed in the example of FIG. 5 that the terminal 102 has generated, as the scenario 302, the node n2 from the node N2 of the inference route 301 in accordance with drag and drop (D&D) by a user.

When the user clicks the connection point c22 of the node n2 by using a cursor 500, the server 101 or the terminal 102 generates the search query 510. The search query 510 has keys 511, data sources 512, and values 513. The keys 511 are items for searching the relational knowledge DB 104. The data sources are locations where the keys 511 are, and the values are item values represented by the keys 511.

The keys 511 include, for example, an edge type, a starting point phrase, a destination phrase, a starting point concept class, a destination concept class, an edge phrase, a phrase in a reference text, a phrase of a title of a reference, and a reference type, a reference document ID, and a context.

The edge type is an item that specifies the type of an edge e connected to a connection point c in the inference route 301 corresponding to a clicked connection point. In the example of FIG. 5, the clicked connection point c is the connection point c22 in the scenario 302, and the connection point C in the inference route 301 corresponding to the connection point c22 is the connection point C22. The data source 512 is the inference route 301 connected to the connection point C22 in the inference route 301 corresponding to the connection point c22. In the example of FIG. 5, the inference route 301 where the edge E2 exists is the data source 512. The value 513 of the edge type is the relationship data 401 defined for the edge E in the inference route 301 connected to the connection point C corresponding to the clicked connection point c. In the example of FIG. 5, “evaluation index” is the value 513 of the edge type.

The starting point phrase is a phrase in the node n that is the starting point. The starting point is an item that specifies the node n having the clicked connection point c. In the example of FIG. 5, the clicked connection point c is the connection point c22, and so the node n2 is the starting point. Because the starting point is in the scenario 302, the data source 512 of the starting point phrase also is the scenario 302. The value 513 of the starting point phrase is a string representing the starting point phrase. In the example of FIG. 5, the value 513 of the starting point phrase is “UGT1A1” representing a phrase in the node n2, which is the starting point.

The destination phrase is an item that specifies a phrase in the destination node. The destination is a node N in the inference route 301 connected from the connection point C in the inference route 301 corresponding to the clicked connection point c via the edge E. In the example of FIG. 5, the clicked connection point c is the connection point c22, and so the node N3 in the inference route 301 connected from the connection point C22 in the inference route 301 corresponding to the connection point c22 via the edge E2 is the destination. Because the destination is in the inference route 301, the data source 512 of the destination phrase also is the inference route 301. The value 513 of the destination phrase is a string representing the destination phrase. In the example of FIG. 5, the value 513 of the destination phrase is “*” (no phrases are specified; this maybe left blank) representing a phrase in the destination node N3.

The starting point concept class is an item specifying the concept class in the node n as the starting point. In the example of FIG. 5, as mentioned above, the node n2 is the starting point. Because the starting point is in the scenario 302, the data source 512 of the starting point concept class also is the scenario 302. The value 513 of the starting point concept class is a string in curly braces {} representing a starting point concept class. In the example of FIG. 5, because there are no strings in curly braces {} in the node n2, the value 513 of the starting point concept class is “*” (no concept classes are specified; this may be left blank).

The destination concept class is an item specifying the concept class in the destination node N. In the example of FIG. 5, as mentioned above, the node N3 is the destination. Because the destination is in the inference route 301, the data source 512 of the destination concept class also is the inference route 301. The value 513 of the destination concept class is a string in curly braces {} representing a destination concept class. In the example of FIG. 5, because there are no strings in curly braces {} in the node N3, the value 513 of the destination concept class is “*” (no concept classes are specified; this maybe left blank).

The edge phrase is an item specifying a phrase given to the edge E in the inference route 301 connected to the connection point C corresponding to the clicked connection point c. In the example of FIG. 5, the edge phrase represents the phrase of the edge E2. The data source 512 of the edge phrase is a search refine box (mentioned below with reference to FIG. 13, and the like) on which a search result of the search query 510 is displayed. The value 513 of the edge phrase is a phrase displayed on the search refine box which is the data source 512 of the edge phrase. In the example of FIG. 5, the value 513 of the edge phrase is “*” (no phrases are specified).

The phrase in the reference text is an item specifying a phrase in the reference text 410 selected from the referenced document. The data source 512 of the phrase in the reference text is the search refine box similarly to the data source 512 of the edge phrase. The value 513 of the phrase in the reference text is a phrase displayed on the search refine box which is the data source 512 of the phrase in the reference text. For example, in a case that the phrase “generation” is included in the reference text 410, the value 513 of the phrase in the reference text is “generation.”

The phrase of the title of the referenced document is an item specifying the phrase representing the title of the referenced document. The data source 512 of the phrase of the title of the referenced document is the search refine box similarly to the data source 512 of the edge phrase. The value 513 of the phrase of the title of the referenced document is a phrase displayed on the search refine box which is the data source 512 of the phrase of the title of the referenced document. For example, in a case that the title of the referenced document is the phrase “UGT1A1,” the value 513 of the phrase in the reference text is “UGT1A1.”

The phrase of the type of the referenced document is an item specifying the phrase representing the type of the referenced document. The type of the referenced document means a classified category of the referenced document, or a field to which the referenced document belongs. The data source 512 of the phrase of the type of the referenced document is the search refine box similarly to the data source 512 of the edge phrase. The value 513 of the phrase of the type of the referenced document is a phrase displayed on the search refine box which is the data source 512 of the phrase of the type of the referenced document. For example, in a case that the type of the referenced document is the phrase “PubMed,” the value 513 of the phrase in the reference text is “PubMed.”

The referenced document ID is an item specifying the referenced document ID. The referenced document ID is identification information uniquely specifying the referenced document. The data source 512 of the referenced document ID is the search refine box similarly to the data source 512 of the edge phrase. The value 513 of the referenced document ID is a string representing the document ID displayed on the search refine box which is the data source 512 of the phrase of the type of the referenced document. For example, in a case that the referenced document ID is the phrase “xxx-12, the value 513 of the phrase in the reference text is “xxx-12.”

The context represents the flow of a sentence, that is, the degree of continuation of meaning of words in a sentence, and is defined for acquiring a search result that continues to the current scenario 302. The data source 512 of the context is the scenario. For example, in the scenario 302, a search result of the node n1 connected to the connection point c21 opposite to the connection point c22 of the clicked node n2 is the data source 512 of the context. In addition, the reference text 410 including “Carcinogen Detoxification Phenotype” representing the phrase 403 of the node n1 in the reference whose reference document ID is “Jia-Long+2004” defined for the edge el, and “UGT1A1” representing the phrase 403 of the node n2 is the value 513 of the context.

In addition, for example, the server 101 may compute the similarity between the value 513 of the context, and the reference text 410 included in the search result of the search query 510 by using cosine similarity or Doc2Vec. In this case, in accordance with prior setting instructions from a user, the server 101 may be set such that if the similarity of a search result is equal to or higher than a predetermined threshold value, the search result is adopted as a search result of the search query 510, or if the similarity of a search result is equal to or lower than a predetermined threshold value, the search result is adopted as a search result of the search query 510.

### <Scenario-Creation-Assisting-Process Procedure>

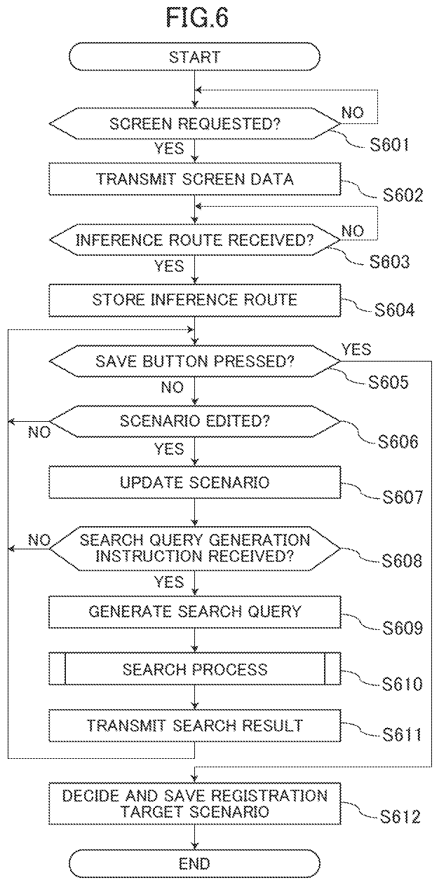

FIG. 6 is a flowchart illustrating an example scenario-creation-assisting-process procedure performed by the server 101. The server 101 waits for a screen request from a terminal 102 (Step S601: No). Upon receiving a screen request (Step S601: Yes), the server 101 transmits a screen data to the terminal 102 (Step S601). Note that in a case that there is a stored scenario 302 (Step S610) generated by a user of the terminal 102, the scenario 302 is readout from the storage device 202 by using the ID of the user as a key 511, and screen data including the scenario 302 is transmitted.

Next, the server 101 waits for reception of an inference route 301 (Step S603: No). In a case that an inference route 301 is received (Step S603: Yes), the inference route 301 is stored on the storage device 202 in association with the ID of the user of the terminal 102 (Step S604). The inference route 301 is used for creation of a search query 510.

Next, the server 101 waits for reception of the pressing of a save button 920 (Step S605: No). In a case that the save button is not pressed (Step S605: No), the server 101 judges whether or not the scenario 302 has been edited (Step S606). Specifically, for example, in a case that a node n is added to or removed from the scenario 302, an edge e is added to or removed from the scenario 302 or a string in a node n is added, modified or removed in the scenario 302 through operation of the terminal 102, the server 101 judges that the scenario 302 has been edited.

In a case that the scenario 302 has not been edited (Step S606: No), the process returns to Step S605. On the other hand, in a case that the scenario 302 has been edited (Step S606: Yes), the server 101 updates the scenario 302 in accordance with the edited content (Step S607). For example, if a node n in the scenario 302 is created as a duplicate of a node N of the inference route 301 in accordance with user operation, the server 101 associates the original node N, and the duplicate node n with each other. In addition, if a node n in the scenario 302 is created as a duplicate of a search result in accordance with user operation, the server 101 associates the duplicate node n, and a node N in the inference route 301 corresponding to the node n with each other. In addition, if nodes n are linked in the scenario 302 by an edge e in accordance with user operation, the server 101 associates the edge e, and an edge E in the inference route 301 corresponding to the edge e.

Then, the server 101 waits for an instruction from the terminal 102 to generate a search query 510 (Step S608: No). The instruction to generate a search query 510 includes information representing a correspondence between nodes n, and nodes N in the latest scenario 302 after the update (Step S607), a correspondence between edges e, and edges E, and a clicked connection point c.

In a case that an instruction to generate a search query 510 is received (Step S608: Yes), as illustrated in FIG. 5, the server 101 generates a search query 510 (Step S609), and executes a search process by using the generated search query 510 (Step S610). Note that the generation of the search query 510 (Step S610) may be executed by the terminal 102.

Then, the server 101 transmits a search result of the search process (Step S608) to the terminal 102 (Step S611), and the process returns to Step S605. At Step S605, if the pressing of the save button 920 is detected (Step S605: Yes), the server 101 stores, on the storage device 202, and in association with the ID of the user of the terminal 102, a scenario including nodes n, in the scenario 302, selected by user operation, and an edge e linking the nodes as a registration target scenario (the scenario 302 itself if no selection is made) (Step S612), and the series of the processes ends.

### <Search Process (Step S608)>

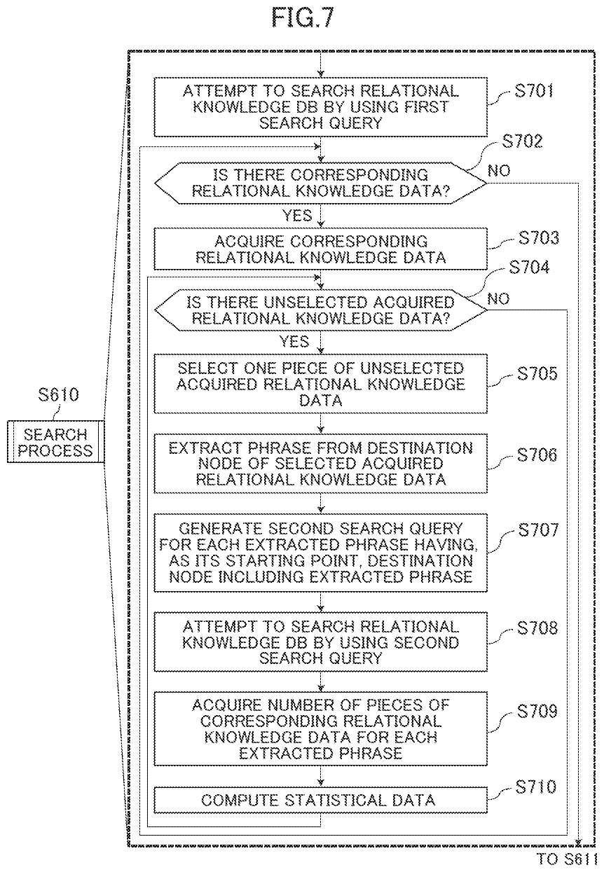

FIG. 7 is a flowchart illustrating a detailed example process procedure of the search process (Step S610) illustrated in FIG. 6. First, the server 101 attempts a search in the relational knowledge DB 104 by using the received search query 510 (hereinafter, a first search query) (Step S701). Next, the server 101 judges whether or not there is relational knowledge data 104-i corresponding to the first search query 510 in the relational knowledge DB 104 (Step S702). In a case that there is relational knowledge data 104-i corresponding to the first search query 510 (Step S702: Yes), the server 101 acquires the relational knowledge data 104-i corresponding to the first search query 510 (Step S703).

Then, the server 101 judges whether or not there is unselected acquired relational knowledge data 104-i in a relational knowledge data (acquired relational knowledge data) group acquired at Step S703 (Step S704). If there is unselected acquired relational knowledge data 104-i (Step S704: Yes), the server 101 selects one piece from the unselected acquired relational knowledge data 104-i (Step S705).

Then, the server 101 executes extraction of phrases 403 from the destination of the acquired relational knowledge data 104-i (Step S706). Specifically, for example, the server 101 extracts one or more phrases 403 from phrases 403 in a destination node N of the acquired relational knowledge data 104-i. The extracted phrases 403 are mutually different phrases 403, but may include overlapping words.

Next, for each extracted phrase 403, the server 101 generates a search query (hereinafter, a second search query) 510 by using as the starting point the destination node N including the extracted phrase 403 (Step S707). Specifically, for example, similarly to the first search query 510, for each extracted phrase 403, the server 101 generates the second search query 510 by using as the starting point the destination node N including the extracted phrase 403.

Then, similarly to Step S701, the server 101 attempts a search in the relational knowledge DB 104 by using the second search query 510 (Step S708). For each extracted phrase 403, the server 101 acquires the number of pieces of relational knowledge data 104-i corresponding to the second search query 510 (Step S709). Then, for each extracted phrase 403, the server 101 computes statistical data about the number of pieces of relational knowledge data 104-i corresponding to the second search query 510 (Step S710), and the process returns to Step S704.

The statistical data is statistical data related to the number of pieces of relational knowledge data 104-i for each extracted phrase 403. For example, it may be a combination of the maximum value, and the minimum value of each number of pieces, or may be the average value or the median of each number of pieces. In addition, it may include a combination of the maximum value, and the minimum value of each number of pieces, and the average value or the median of each number of pieces.

In a case that there is no unselected acquired relational knowledge data 104-i at Step S704 (Step S704: No), the process returns to Step S702. In a case that there is no relational knowledge data 104-i corresponding to the first search query 510 at Step S702 (Step S702: No), the search process (Step S608) ends, and the process proceeds to Step S609.

### <Example Phrase Extraction>

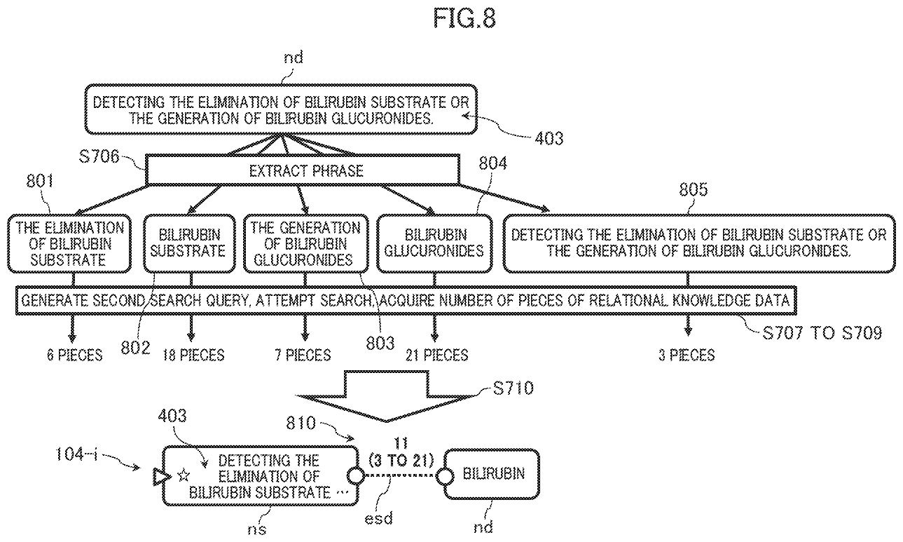

FIG. 8 is an explanatory diagram illustrating example phrase extraction illustrated in Steps S706 to S710 in FIG. 7. In FIG. 8, a phrase 403 in a node n as an extraction target of a phrase in the relational knowledge data 104-i is “detecting the elimination of bilirubin substrate or the generation of bilirubin glucuronides.” The node n as the extraction target is a destination nd for the first search query 510, but is a starting point ns for the second search query 510. In FIG. 8, before the execution of the phrase extraction (Step S706), the node n as the extraction target is denoted as the destination nd, and after the execution of the phrase extraction (Step S706), the node having been the extraction target is denoted as the starting point ns.

Extracted phrases 801 to 804 are sub-phrases extracted from the phrase 403. An extracted phrase 805 is the phrase 403 itself. The number of extracted phrases is equal to or larger than one, and is determined in according with prior setting. In addition, the extraction technique may be an existing grammatical extraction method in which noun phrases are acquired, or sentences are divided noun phrase by noun phrase, may be a method of extracting strings that match part of a phrase 403 in an external dictionary that can be accessed by the server 101, or may be an extraction method that uses machine learning in which a phrase output from a learning model by inputting a phrase 403, or a phrase 403, and a scenario 302 in the middle of creation is used as an extracted phrase.

In the example of FIG. 8, the numbers of pieces of relational knowledge data corresponding to the extracted phrase 801, the extracted phrase 802, the extracted phrase 803, the extracted phrase 804, the extracted phrase 805 is 6, 18, 7, 21, and 3, respectively.

In addition, in the example of FIG. 8, statistical data 810 includes “11” as the average of the numbers of pieces of relational knowledge data corresponding to the extracted phrases 801 to 805, and “3 to 21” as the range of the numbers of the pieces of relational knowledge data as determined from “three” as the minimum number, and “21” as the maximum number.

### <Example Scenario Creation>

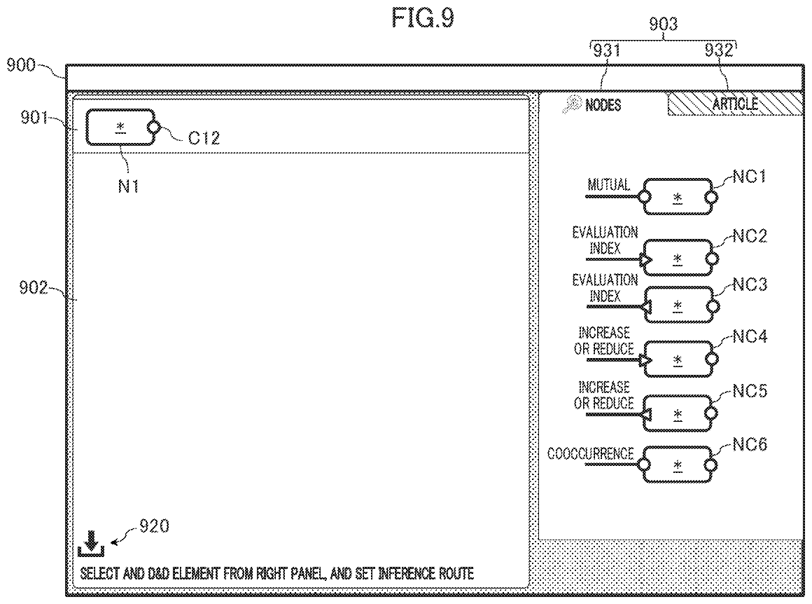

Next, example scenario creation performed in accordance with user operation is explained with reference to FIG. 9 to FIG. 21. Note that if there is even one node n in a scenario creation area 902 mentioned below, it is deemed that there is a scenario 302 even if it is not stored on the server 101 (Step S610).

FIG. 9 is an explanatory diagram illustrating example scenario creation 1 performed in accordance with user operation. FIG. 9 illustrates one example of a display screen 900 of a terminal 102 before screen data is transmitted to the terminal 102 at Step S602, and the creation of an inference route 301, and a scenario 302 are started. The display screen 900 has an inference-route creation area 901, a scenario creation area 902, and a search result display area 903. The inference-route creation area 901 displays an inference route 301. The inference-route creation area 901 initially displays a node N1, and a connection point C12. It should be noted however that neither a concept class nor a phrase is specified for the node N1.

The scenario creation area 902 can display a scenario 302. In FIG. 9, a scenario 302 is not created yet, and so a scenario 302 is not displayed. A lower section of the scenario creation area 902 displays the save button 920. If the save button 920 is pressed, the latest scenario 302 displayed on the scenario creation area 902 is transmitted from the terminal 102 to the server 101.

The search result display area 903 is the search refine box (see FIG. 5) having a node tab 931, and an article tab 932. The node tab 931 is a panel that displays node candidates NC1 to NC6 necessary for creation of a scenario 302 in such a manner that the node candidates NC1 to NC6 can be used for the scenario creation, displays a search result of the first search query 510 in such a manner that the search result can be used for the creation of the scenario 302, and so on. The article tab 932 displays articles related to the search result of the first search query 510. FIG. 9 illustrates a state where the node tab 931 is selected, and the node candidates NC1 to NC6 are displayed in such a manner that the node candidates NC1 to NC6 can be used. The node candidates NC1 to NC6 can be duplicated in the inference-route creation area 901 by drag and drop.

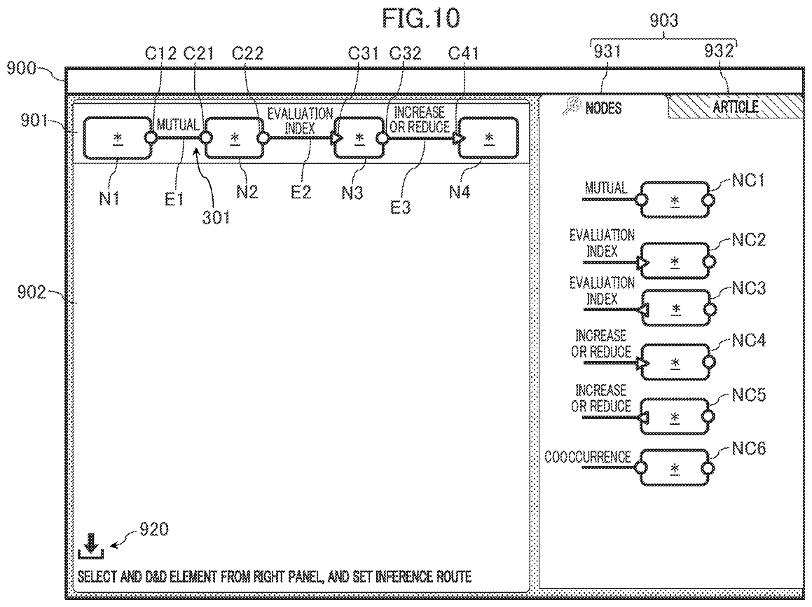

FIG. 10 is an explanatory diagram illustrating example scenario creation 2 performed in accordance with user operation. FIG. 10 illustrates a state where node candidates NC are duplicated in the inference-route creation area 901. In FIG. 10, a user drags and drops the node candidate NC1 in the inference-route creation area 901, and, as a result, a duplicate of the node candidate NC1 is created as an edge E1, and a node N2, and is connected to the node N1. Next, the user drags and drops the node candidate NC2 in the inference-route creation area 901, and, as a result, a duplicate of the node candidate NC2 is created as an edge E2, and a node N3, and is connected to the node N2. Next, the user drags and drops the node candidate NC4 in the inference-route creation area 901, and, as a result, a duplicate of the node candidate NC4 is created as an edge E3, and a node N4, and is connected to the node N3.

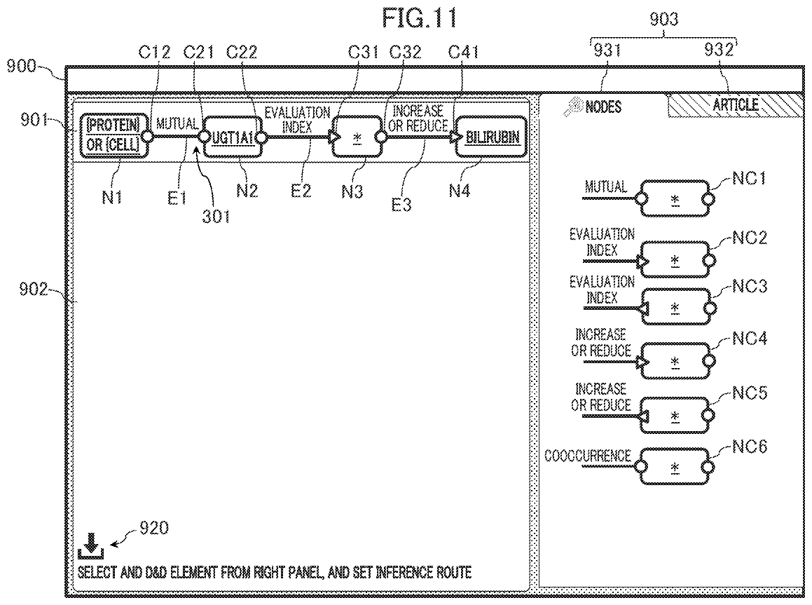

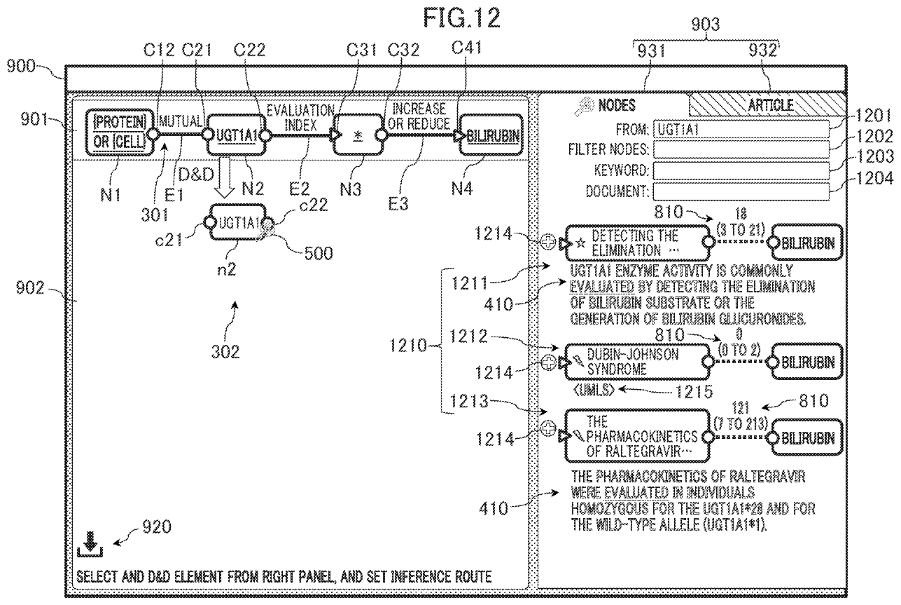

FIG. 11 is an explanatory diagram illustrating example scenario creation 3 performed in accordance with user operation. FIG. 11 illustrates a state which follows the state of FIG. 10. Concept classes 402 or phrases 403 to be conditions are input to the nodes N1 to N4 in the inference-route creation area 901 in accordance with user operation. In FIG. 11, a concept class 402 is input for the node N1, phrases 403 are input for the nodes N2, and N4, and a condition is not specified for the node N3. The server 101 retains the created inference route 301.

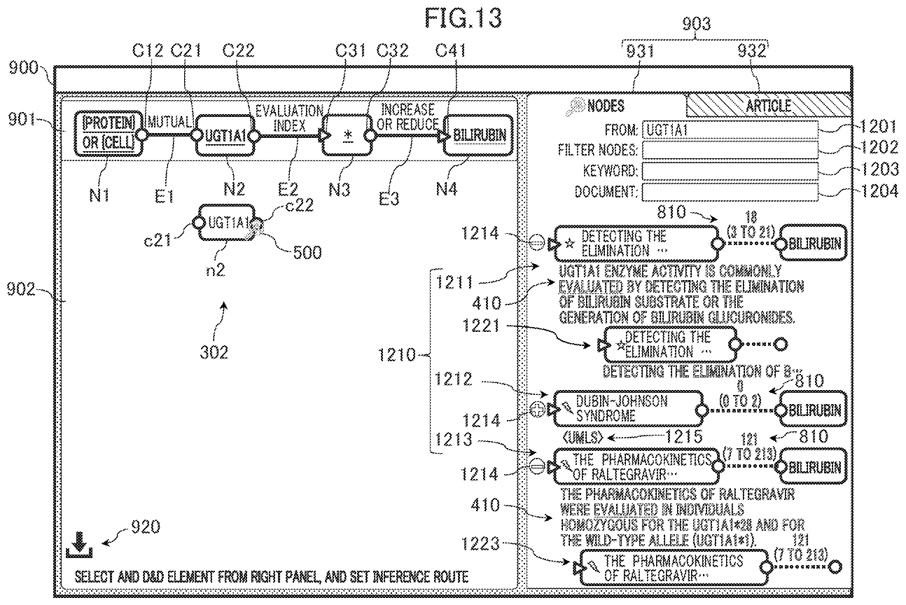

FIG. 12 is an explanatory diagram illustrating example scenario creation 4 performed in accordance with user operation. FIG. 12 illustrates a state which follows the state of FIG. 11. The node N2 of the inference route 301 is duplicated as a node n2 in the scenario creation area in accordance with drag and drop D&D. The server 101 retains a correspondence between the node n2, and the node N2. Note that connection points c21, and c22 of the node n2 are connection points c which are duplicates of connection points C21, and C22 of the node N2. The connection points c21, and c22 can be pressed in accordance with user operation.

In addition, after the completion of the inference route 301, the display of the node tab 931 is switched from the display of node candidates to the display of a search result in accordance with user operation. The node tab 931 has a starting-point-condition input field 1201, a destination condition input field 1202, a reference-text-condition input field 1203, and a metadata condition input field 1204. In the starting-point-condition input field 1201, a string representing a concept class or a phrase to be a condition for searching for a starting point is input. In the destination condition input field 1202, a string representing a concept class 402 or a phrase 403 to be a condition for searching for a destination is input. In the reference-text-condition input field 1203, a string to be a condition for searching for a reference text 410 is input. In the metadata condition input field 1204, a string to be a condition for searching for metadata included in relational knowledge data 104-i is input.

In addition, in FIG. 12, for example if a user presses the connection point c22, the terminal 102 generates a first search query 510, and transmits the first search query 510 to the server 101 as illustrated in FIG. 5. As a result of the transmission, the terminal 102 receives a search result from the server 101, and displays a search result group 1210 on the node tab 931. Note that in a case of the pressing of a connection point c, a concept class 402 or a phrase 403 to be a condition of a starting point including the connection point c (in the case of the present example, “UGT1A1” representing a phrase 403) is automatically set in the starting-point-condition input field 1201.

The search result group 1210 includes zero or more search results. In FIG. 12, as an example, the search result group 1210 includes three search results 1211 to 1213. The search results 1211 to 1213 are relational knowledge data 104-i covering concept classes 402 or phrases 403 to be conditions of a starting point of the first search query 510. In addition, relational knowledge data 104-i having a starting point which a starting point phrase 403 of any of the search results 1211 to 1213 matches or partially matches is referred to as partially-matching relational knowledge data 104-i. Plus buttons 1214 are displayed for the search results 1211 to 1213 for which there is partially-matching relational knowledge data 104-i. By pressing the plus buttons 1214, the partially-matching relational knowledge data 104-i can be additionally displayed.

The search results 1211 to 1213 display statistical data 810. In addition, the search results 1211, and 1213 include reference texts 410. In the reference texts 410, for example, values 513 of conditions specified in the first search query 510 (the starting point concept class 402 or phrase 403, the destination concept class 402 or phrase 403, edge type) are displayed in a more noticeable format. In addition, as illustrated in the search result 1212, instead of reference texts 410, a link 1215 which is access information that enables access to a knowledge DB like the Unified Medical Language System (UMLS) may be displayed.

FIG. 13 is an explanatory diagram illustrating example scenario creation 5 performed in accordance with user operation. FIG. 13 illustrates a state which follows the state of FIG. 12. The plus buttons 1214 of the search results 1211, and 1213 are pressed. By pressing the plus buttons 1214 of the search results 1211, and 1213, search results 1221, and 1223 including the partially-matching relational knowledge data 104-i are displayed.

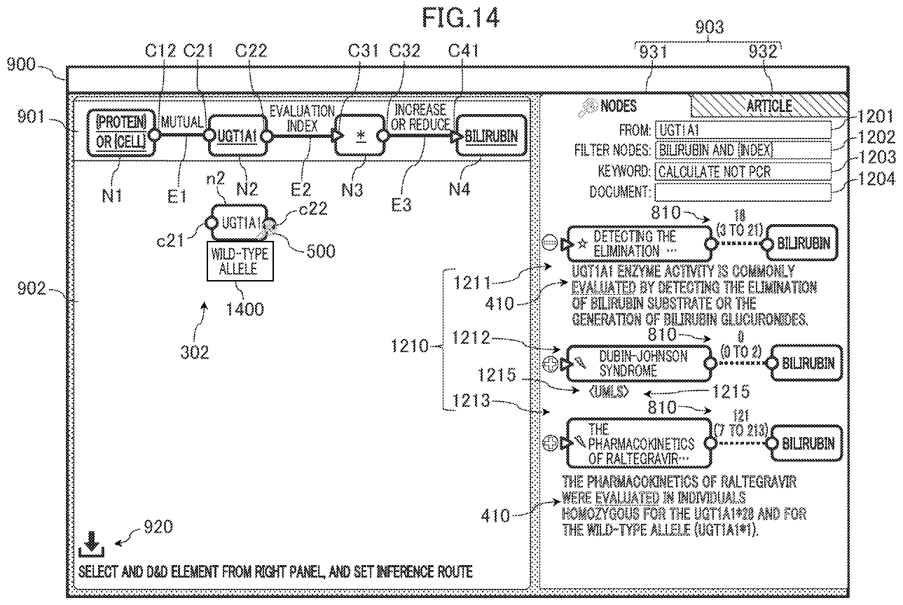

FIG. 14 is an explanatory diagram illustrating example scenario creation 6 performed in accordance with user operation. “bilirubin AND {Index}” is input in the destination condition input field 1202 in accordance with user operation, and this is a condition for searching for a destination whose phrase is “bilirubin,” and whose concept class 402 is “{Index}.” In addition, “calculate NOT per” is input in the reference-text-condition input field 1203, and this is a condition for searching for a reference text 410 including “calculate,” but not including “per.” By acquiring these conditions from the terminal 102, the server 101 can refine the search result group 1210 again.

In addition, the terminal 102 may display a box 1400 near a node (e.g. below a node) in the scenario creation area 902. In accordance with user operation, a string such as a synonym of a concept class 402 or a phrase 403 of the node n2 can be freely input to the box. In addition, the synonym of the concept class 402 or the phrase 403 of the node n2 may be automatically input to the box. Specifically, for example, as a result of the transmission of the first search query 510, the server 101 searches the relational knowledge DB 104 or an external knowledge DB for the synonym of the concept class 402 or the phrase 403 of the node n2, and replies to the terminal 102 with a result of the search. Thereby, the terminal 102 can display, in the box, the synonym of the concept class 402 or the phrase 403 of the node n2 found through the search.

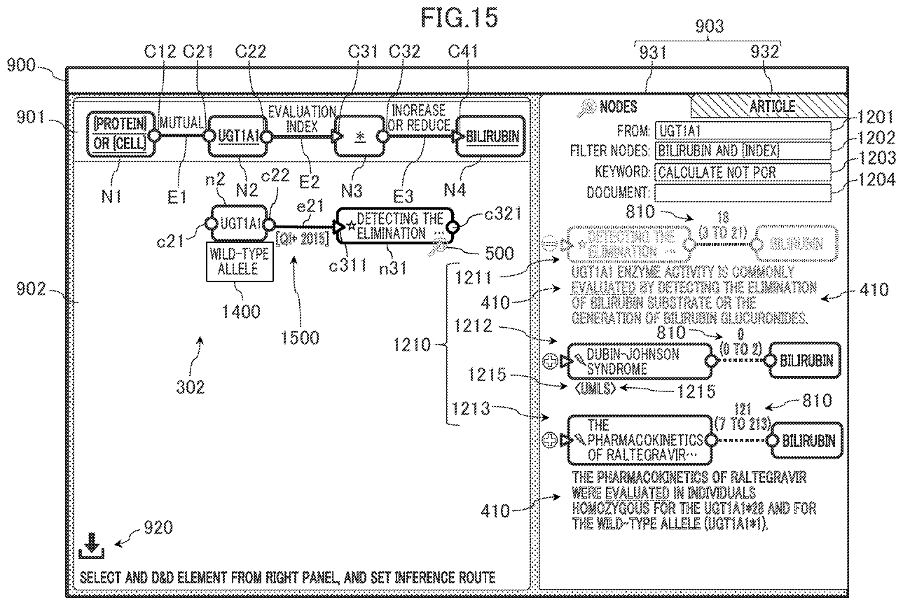

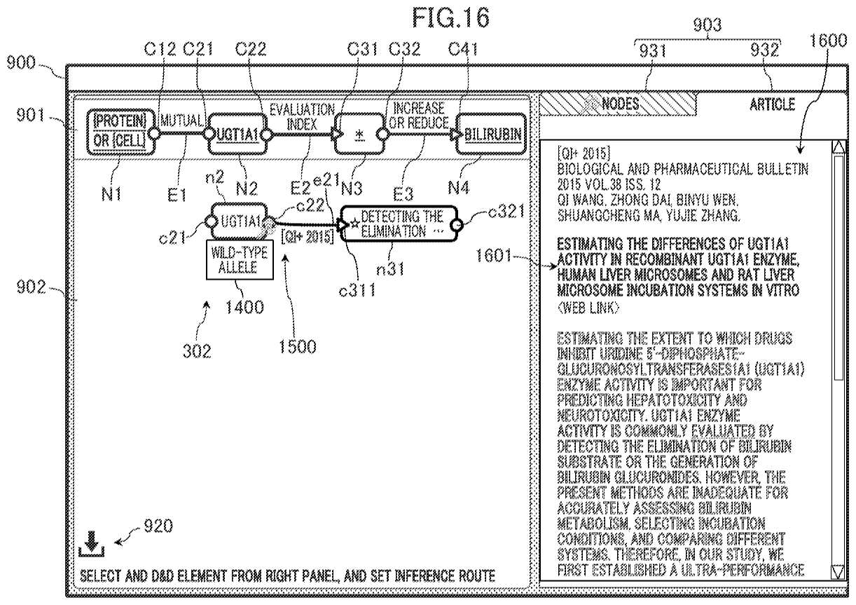

FIG. 15 is an explanatory diagram illustrating example scenario creation 7 performed in accordance with user operation. FIG. 15 illustrates a state which follows the state of FIG. 14. The search result 1211 is duplicated in the scenario creation area 902 in accordance with drag and drop, and the duplicate is linked with the node n2. Specifically, for example, in accordance with user operation, the terminal 102 draws an edge e21 between the node n2, and a node n31 which is a duplicate, and links the node n2, and the node n31. Thereby, the server 101 associates the node n31 which is the destination of the node n2 with the node N3 which is the destination of the node N2 in the inference route 310, and associates the edge e21 with the edge E2 between the nodes N2, and N3. The dragged and dropped search result 1211 is displayed with a lighter color as compared with the other search results 1212, and 1213, for example, such that it is possible to visually recognize that the search result 1211 has been dragged and dropped.

In addition, [QI+2015] displayed below the edge e21 in the scenario creation area 902 is a referenced document ID 1500 of a reference text in the search result 1211. A link to the referenced document may be embedded in the document ID 1500.

FIG. 16 is an explanatory diagram illustrating example scenario creation 8 performed in accordance with user operation. FIG. 16 illustrates a state which follows the state of FIG. 15. The article tab 932 is selected in accordance with user operation. By selecting the article tab 932, a referenced document 1600 specified with a document ID displayed in the scenario creation area 902 is displayed. In the referenced document 1600, for example, values 513 of conditions specified in the first search query 510 (the starting point concept class or phrase, the destination concept class or phrase, edge type) are displayed in a more noticeable format.

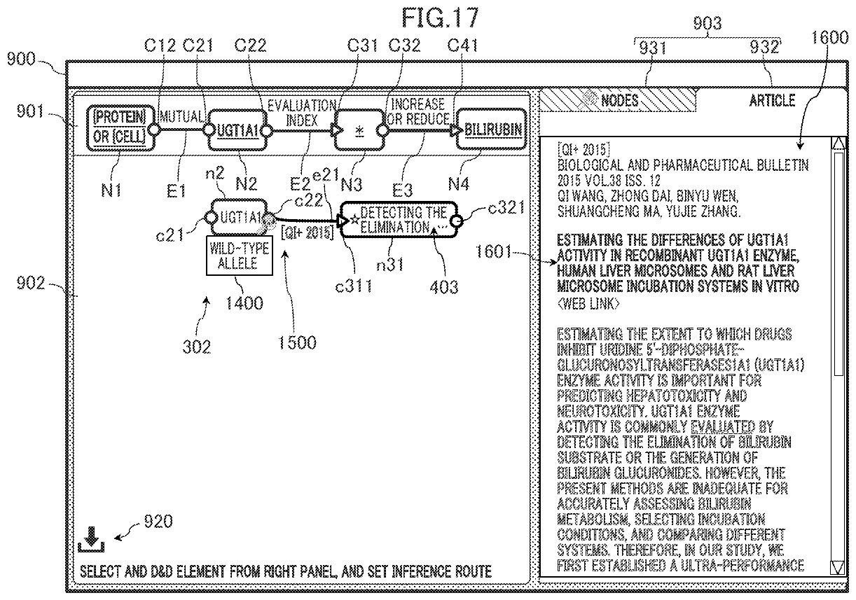

FIG. 17 is an explanatory diagram illustrating example scenario creation 9 performed in accordance with user operation. FIG. 17 illustrates a state which follows the state of FIG. 16. A user is editing the scenario 302. Specifically, for example, the phrase 403 in the node n31 is corrected. In this manner, a condition in a node n displayed in the scenario creation area 902 can be edited in accordance with user operation.

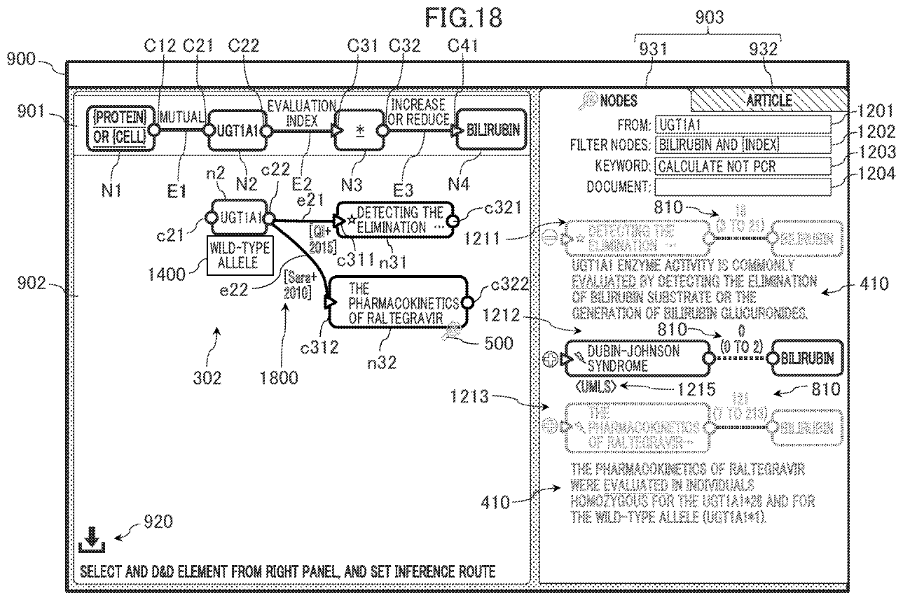

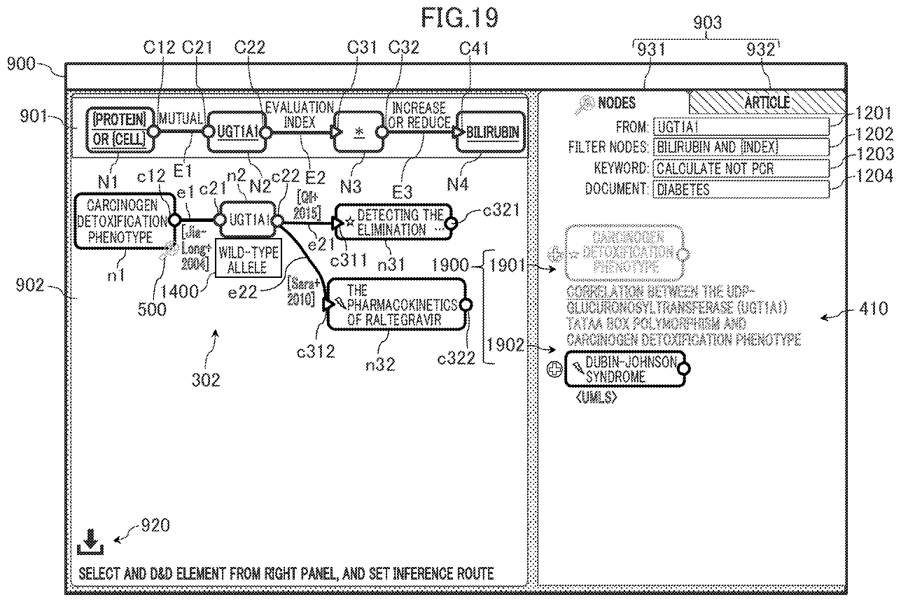

FIG. 18 is an explanatory diagram illustrating example scenario creation 10 performed in accordance with user operation. FIG. 18 illustrates a state which follows the state of FIG. 17. The search result 1213 is duplicated in the scenario creation area 902 in accordance with drag and drop, and the duplicate is linked with the node n2. Specifically, for example, in accordance with user operation, the terminal 102 draws an edge e22 between the node n2, and a node n32 which is a duplicate, and links the node n2, and the node n32. Thereby, the server 101 associates the node n32 which is the destination of the node n2 with the node N3 which is the destination of the node N2 in the inference route 310, and associates the edge e22 with the edge E2 between the nodes N2, and N3. The dragged and dropped search result 1213 is displayed with a lighter color as compared with the other search result 1212, for example, such that it is possible to visually recognize that the search result 1213 has been dragged and dropped.

In addition, [Sara+2010] displayed below the edge e21 in the scenario creation area 902 is a referenced document ID 1800 of a reference text in the search result 1213. A link to the referenced document may be embedded in the document ID 1800. In this manner, a plurality of search results can be connected to the one connection point c22.

FIG. 19 is an explanatory diagram illustrating example scenario creation 11 performed in accordance with user operation. FIG. 19 illustrates a state which follows the state of FIG. 18. A search result 1901 is duplicated in the scenario creation area 902 in accordance with drag and drop, and the duplicate is linked with the node n2. In FIG. 19, “diabetes” is input in the metadata condition input field 1204 in accordance with user operation, and by acquiring, from the terminal 102, conditions specified in the starting-point-condition input field 1201 to the metadata condition input field 1204, the server 101 refines the search result group 1210 again, and transmits a search result group 1900 to the terminal 102. Thereby, the search result group 1900 is displayed on the node tab 931 of the terminal 102.

The user drags and drops the search result 1901 from the search result group 1900 to create a duplicate of the search result 1901 in the scenario creation area 902. Specifically, for example, in accordance with user operation, the terminal 102 draws an edge el between the node n2, and a node n1 which is a duplicate, and links the node n2, and the node n1. Thereby, the server 101 associates the node n1 which is the destination of the node n2 with the node N1 which is the destination of the node N2 in the inference route 310, and associates the edge el with the edge E1 between the nodes N2, and N1. In this manner, the scenario 302 is updated to include the node n1, the edge el, the node n2, the edge e21, the node n31, the edge e22, and the node n32.

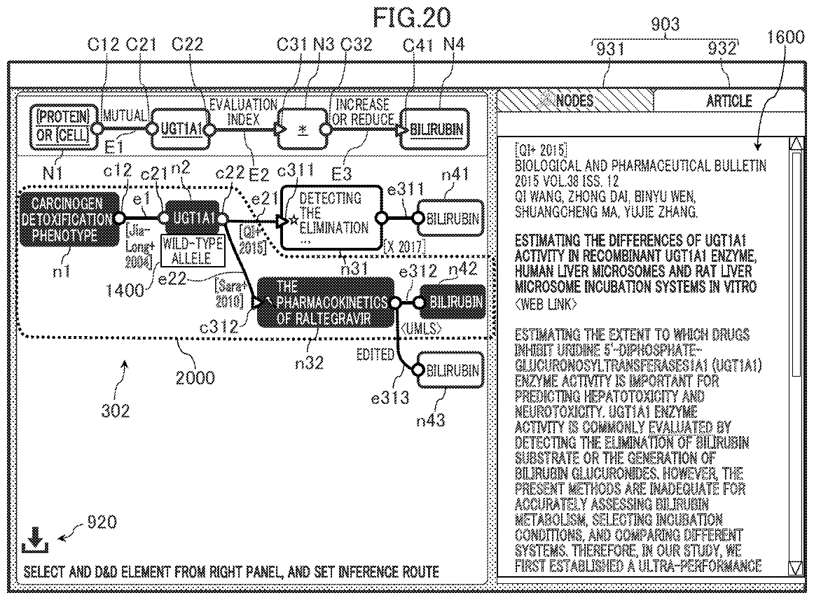

FIG. 20 is an explanatory diagram illustrating example scenario creation 12 performed in accordance with user operation. FIG. 20 illustrates a state which follows the state of FIG. 19. Nodes n41 to n43, and edges e321 to e323 are further added to the scenario 302. Specifically, for example, in accordance with user operation, the terminal 102 draws an edge e311 between the node n31, and the node n41 which is a duplicate, and links the node n31, and the node n41. Thereby, the server 101 associates the node n41 which is the destination of the node n31 with the node N4 which is the destination of the node N3 in the inference route 310, and associates the edge e311 with the edge E3 between the nodes N3, and N4.

Similarly, in accordance with user operation, the terminal 102 draws an edge e312 between the node n32, and the node n42 which is a duplicate, and links the node n32, and the node n42. Thereby, the server 101 associates the node n42 which is the destination of the node n32 with the node N4 which is the destination of the node N3 in the inference route 310, and associates the edge e312 with the edge E3 between the nodes N3, and N4.

Similarly, in accordance with user operation, the terminal 102 draws an edge e313 between the node n32, and the node n43 which is a duplicate, and links the node n32, and the node n43. Thereby, the server 101 associates the node n43 which is the destination of the node n32 with the node N4 which is the destination of the node N3 in the inference route 310, and associates the edge e313 with the edge E3 between the nodes N3, and N4.

In addition, a user can select a scenario 2000 to be a registration target. Specifically, for example, a user uses the input device 203 to select the node n1, the node n2, the node n31, the node n32, and the node n42 from the scenario 302 (displayed as black-pained portions in FIG. 20). The server 101 sets, as the registration target scenario 2000, the selected node n1, node n2, node n31, node n32, and node n42, and the edges el, e22, and e312 therebetween. Then, when the user presses the save button 920 by using the input device 203, the terminal 102 stores, on the storage device 202, the registration target scenario 2000 in association with the ID of the user of the terminal 102 (Step S610).

In this manner, in the embodiment mentioned above, it is possible to attempt to enhance the efficiency of creating a scenario 302, and to enhance the quality of a scenario 302 to be created.

Note that in the client-server-type creation assisting system 100 explained in the embodiment mentioned above, the server 101 is the creation assisting device that assists creation of a scenario 302 in accordance with operation through the terminal 102. In contrast to this, the terminal 102 may be the creation assisting device that generates a search query 510, and causes a server to perform a search. In addition, although the client-server-type creation assisting system 100 is explained in the embodiment mentioned above, it may be realized by a standalone-type server 101.

In addition, the creation assisting device according to the first embodiment, and second embodiment mentioned above can be configured as described below in (1) to (13).

(1) A creation assisting device (a server 101, a terminal 102) including a processor 201 that executes a program, and a storage device 202 that stores the program can access a relational knowledge DB 104 that stores a set of relational knowledge data 104-i including two nodes ns, and nd defining knowledge, and an edge esd that defines a relationship between the two nodes ns, and nd, and links the two nodes ns, and nd. The processor 201 executes: an acquisition process (Steps S603, 604) of acquiring an inference route 301 that defines an order of a plurality of pieces of knowledge that form a hypothesis; an updating process (Step S607) of updating a scenario 302 that embodies the hypothesis in a case that a second node n2 corresponding to a first node N2 in an inference route 301 acquired in the acquisition process is added to the scenario 302; a generation process (Step S609) of generating a first search query 510 for searching for a second destination node n31 from the second node n2, on a basis of the first node N2 in the inference route 301, a first destination node N3 from the first node N2, and a first edge E2 that links the first node N2, and the first destination node N3; a search process (Step S610) of searching the relational knowledge DB 104 for particular first relational knowledge data 104-i corresponding to the first search query 510 generated in the generation process; and an output process (Step S611) of outputting the particular first relational knowledge data 104-i found through the search in the search process.

Thereby, a user can link nodes n that define the plurality of pieces of knowledge by edges e, and create a scenario 302. Specifically, for example, because a destination node n can be selected from the particular first relational knowledge data 104-i that is given as a search result of the first search query 510, scenarios 302 which are irrelevant to the interest of the user are not generated. That is, by searching for the particular first relational knowledge data 104-i by using the first search query 510, a scenario 302 that satisfies a condition set for each node n or each edge e of a scenario 302 is created. In this manner, it is possible to attempt to enhance the efficiency of creating a scenario 302, and to enhance the quality of the scenario 302 to be created.

(2) In the creation assisting device according to (1) described above, in the generation process, the processor 201 generates a second search query 510 for searching for a fourth destination node n41 from the second destination node n31 on a basis of the first destination node N3 in the inference route 301, a third destination node N4 from the first destination node N3, and a third edge E3 linking the first destination node N3, and the third destination node N4; in the search process, the processor 201 searches the relational knowledge DB 104 for particular second relational knowledge data 104-i corresponding to the second search query 510 generated in the generation process; and in the output process, the processor 201 outputs the particular first relational knowledge data 104-i, and the number of pieces of the particular second relational knowledge data 104-i.

Thereby, a user can check the presence of fourth destination nodes n41 at the time of the search of the second destination node n31. Accordingly, it is possible to avoid the addition, to a scenario 302, of a second destination node n31 for which there are no fourth destination nodes n41.

(3) In the creation assisting device according to (2) described above, the processor 201 executes an extraction process (Step S706) of extracting a plurality of substrings including part of a string of knowledge defined for the second destination node n3 from the string; in the generation process, the processor 201 generates the second search query 510 using, as the second destination node n3, each of strings extracted at the extraction process; in the search process, the processor 201 searches the relational knowledge DB 104 for the particular second relational knowledge data 104-i about each of the second search queries 510; the processor 201 executes a computation process (Step S710) of computing statistical data 810 related to the number of pieces of the particular second relational knowledge data 104-i found through the search of each of the second search queries 510; and in the output process, the processor 201 outputs the particular first relational knowledge data 104-i, and the statistical data 810 computed in the computation process.

Due to the extraction process (Step S706), it is possible to attempt to enhance the comprehensiveness of search patterns of second search queries 510 having a second destination node n31 as starting points. Thereby, a user can comprehensively check the presence of fourth destination nodes n41 at the time of the search of the second destination node n31. Accordingly, it is possible to avoid the addition, to a scenario 302, of a second destination node n31 for which there are no fourth destination nodes n41.

(4) In the creation assisting device according to (1) described above, the relational knowledge data 104-i has related information of the relational knowledge data 104-i, and in the output process, the processor 201 outputs the particular second relational knowledge data 104-i including the related information.

Thereby, when selecting destination nodes n from the particular first relational knowledge data 104-i given as a search result of the first search query 510, a user can refer to the related information, and use it as an index for making a judgment about addition of the destination nodes n to the scenario 302.

(5) In the creation assisting device according to (4) described above, the related information is a reference text 410 to be a ground of the relational knowledge data 104-i.

Thereby, when selecting destination nodes n from the particular first relational knowledge data 104-i given as a search result of the first search query 510, a user can refer to the reference text 410, and use it as an index for making a judgment about addition of the destination nodes n to the scenario 302.

(6) In the creation assisting device according to (4) described above, the related information is a link 1215 to a reference to be aground of the relational knowledge data 104-i.

Thereby, when selecting destination nodes n from the particular first relational knowledge data 104-i given as a search result of the first search query 510, a user can refer to a Web page which is the linked destination of the link 1215, and use it as an index for making a judgment about addition of the destination nodes n to the scenario 302.

(7) In the creation assisting device according to (5) described above, in the output process, the processor 201 outputs a string representing knowledge defined for each of the second node n2, and the second destination node n31 in the reference text 410, and a string representing relevance defined for the first edge E2 such that the string representing the knowledge, and the string representing the relevance can be displayed in a more noticeable format.

Thereby, when selecting destination nodes n from the particular first relational knowledge data 104-i given as a search result of the first search query 510, a user can refer to the portions of the reference text 410 that are displayed in the more noticeable format, and use it as an index for making a judgment about addition of the destination nodes n to the scenario 302.

(8) In the creation assisting device according to (1) described above, in the updating process, the processor 201 updates the scenario 302 in a case that, in the scenario 302, the second node n2, and the second destination node n31 in the particular first relational knowledge data 104-i are linked by a second edge e21 corresponding to the first edge E2.

Thereby, the creation of a scenario 302 can be continued while the scenario 302 is in the latest state.

(9) In the creation assisting device according to (8) described above, in the generation process, the processor 201 generates a third search query 510 for searching for a fourth destination node n41 from the second destination node n31 on a basis of the first destination node N3 in the inference route 301, a third destination node N4 from the first destination node N3, and a third edge E3 linking the first destination node N3, and the third destination node N4; in the search process, the processor 201 searches the relational knowledge DB 104 for particular second relational knowledge data 104-i corresponding to the third search query 510 generated in the generation process; and in the output process, the processor 201 outputs the particular second relational knowledge data 104-i.

Thereby, the creation assisting device can generate a search query by using the scenario 302 in the latest state.

(10) In the creation assisting device according to (9) described above, the relational knowledge data 104-i has related information of the relational knowledge data 104-i; in the generation process, the processor 201 generates the third search query 510 on a basis of the first destination node N3 in the inference route 301, the third destination node N4, the third edge E3, and the related information included in the particular first relational knowledge data 104-i; and in the output process, the processor 201 outputs the particular second relational knowledge data 104-i, and the related information.

Thereby, the creation assisting device can perform a search by using the related information included in the particular first relational knowledge data 104-i which is a result of the previous search.

(11) In the creation assisting device according to (10) described above, the related information is a reference text 410 to be a ground of the relational knowledge data 104-i.

(12) In the creation assisting device according to (10) described above, in the generation process, the processor 201 decides relational knowledge data 104-i corresponding to the third search query 510 as the particular second relational knowledge data 104-i on a basis of a similarity between related information of the third search query 510, and related information of the relational knowledge data 104-i corresponding to the third search query 510.

Thereby, a search can be performed in such a manner that the relational knowledge data 104-i corresponding to the third search query 510 is decided as the particular second relational knowledge data 104-i in a case that the similarity is equal to or higher than the threshold value, or in such a manner that the relational knowledge data 104-i corresponding to the third search query 510 is decided as the particular second relational knowledge data 104-i in a case that the similarity is equal to or lower than a threshold value. Thereby, the particular second relational knowledge data 104-i can be refined efficiently.

(13) In the creation assisting device according to (1) described above, the processor 201 executes a storage process (Step S612) of deciding a registration target scenario 2000 by selecting anode group, and an edge group linking the node group from the scenario 302, and storing the registration target scenario 2000 in the storage device 202.

Thereby, the creation assisting device makes it possible to easily execute the storage of the necessary scenario 2000 in the scenario 302 only by selecting the nodes in accordance with user operation.

Note that the present invention is not limited to the embodiments mentioned before, but include various modification examples, and equivalent configurations within the gist of attached claims. For example, the embodiments mentioned before are explained in detail in order to explain the present invention in an easy-to-understand manner, and the present invention is not necessarily limited to embodiments including all the configurations explained. In addition, some of configurations of an embodiment may replace configurations of another embodiment. In addition, configurations of an embodiment may be added to configurations of another embodiment. In addition, other configurations may be added to some of configurations of each embodiment, some of configurations of each embodiment may be removed, or some of configurations of each embodiment may be replaced by other configurations.

In addition, each configuration, functionality, processing section, processing means or the like mentioned before may partially or entirely be realized by hardware by designing it with an integrated circuit, and so on, for example, or may be realized by software by the processor 201 interpreting a program to realize each functionality, and executing the program.

Information such as programs, tables, and files for realizing each functionality can be stored on a storage device such as a memory, a hard disk or an SSD (Solid State Drive), or on a recording medium such as an IC (Integrated Circuit) card, a SD card or a DVD (Digital Versatile Disc).

In addition, control lines, and information lines that are considered to be necessary for the explanation of each embodiment are illustrated, and all control lines, and information lines necessary for implementation are not necessarily illustrated. It may be considered that actually almost all configurations are connected mutually.

What is claimed is:

1. A creation assisting device comprising a processor that executes a program, and a storage device that stores the program, wherein
the creation assisting device can access a database that stores a set of relational knowledge data including two nodes defining knowledge, and an edge that defines a relationship between the two nodes, and links the two nodes, and
the processor executes:
an acquisition process of acquiring an inference route that defines an order of a plurality of pieces of knowledge that form a hypothesis;
an updating process of updating a scenario that embodies the hypothesis in a case that a second node corresponding to a first node in an inference route acquired in the acquisition process is added to the scenario;
a generation process of generating a first search query for searching for a second destination node from the second node, on a basis of the first node in the inference route, a first destination node from the first node, and a first edge that links the first node, and the first destination node;
a search process of searching the database for particular first relational knowledge data corresponding to the first search query generated in the generation process; and
an output process of outputting the particular first relational knowledge data found through the search in the search process.

2. The creation assisting device according to claim 1, wherein
in the generation process, the processor generates a second search query for searching for a fourth destination node from the second destination node on a basis of the first destination node in the inference route, a third destination node from the first destination node, and a third edge linking the first destination node, and the third destination node,
in the search process, the processor searches the database for particular second relational knowledge data corresponding to the second search query generated in the generation process, and
in the output process, the processor outputs the particular first relational knowledge data, and the number of pieces of the particular second relational knowledge data.

3. The creation assisting device according to claim 2, wherein
the processor executes an extraction process of extracting a plurality of substrings including part of a string of knowledge defined for the second destination node from the string;
in the generation process, the processor generates the second search query using, as the second destination node, each of strings extracted at the extraction process,
in the search process, the processor searches the database for the particular second relational knowledge data about each of the second search queries,
the processor executes a computation process of computing statistical data related to the number of pieces of the particular second relational knowledge data found through the search of each of the second search queries, and
in the output process, the processor outputs the particular first relational knowledge data, and the statistical data computed in the computation process.

4. The creation assisting device according to claim 1, wherein
the relational knowledge data has related information of the relational knowledge data, and
in the output process, the processor outputs the particular second relational knowledge data including the related information.

5. The creation assisting device according to claim 4, wherein the related information is document data related to a reference to be a ground of the relational knowledge data.

6. The creation assisting device according to claim 4, wherein the related information is information about access to a reference to be a ground of the relational knowledge data.

7. The creation assisting device according to claims, wherein in the output process, the processor outputs a string representing knowledge defined for each of the second node, and the second destination node in the document data, and a string representing relevance defined for the first edge such that the string representing the knowledge, and the string representing the relevance can be displayed in a more noticeable format.

8. The creation assisting device according to claim 1, wherein
in the updating process, the processor updates the scenario in a case that, in the scenario, the second node, and the second destination node in the particular first relational knowledge data are linked by a second edge corresponding to the first edge.

9. The creation assisting device according to claim 8, wherein
in the generation process, the processor generates a third search query for searching for a fourth destination node from the second destination node on a basis of the first destination node in the inference route, a third destination node from the first destination node, and a third edge linking the first destination node, and the third destination node,
in the search process, the processor searches the database for particular second relational knowledge data corresponding to the third search query generated in the generation process, and
in the output process, the processor outputs the particular second relational knowledge data.

10. The creation assisting device according to claim 9, wherein
the relational knowledge data has related information of the relational knowledge data,
in the generation process, the processor generates the third search query on a basis of the first destination node in the inference route, the third destination node, the third edge, and the related information included in the particular first relational knowledge data, and
in the output process, the processor outputs the particular second relational knowledge data, and the related information.

11. The creation assisting device according to claim 10, wherein the related information is document data related to a reference to be a ground of the relational knowledge data.

12. The creation assisting device according to claim 10, wherein
in the generation process, the processor decides relational knowledge data corresponding to the third search query as the particular second relational knowledge data on a basis of a similarity between related information of the third search query, and related information of the relational knowledge data corresponding to the third search query.

13. The creation assisting device according to claim 1, wherein the processor executes a storage process of deciding a registration target scenario by selecting a node group, and an edge group linking the node group from the scenario, and storing the registration target scenario in the storage device.

14. A creation assisting method executed by a creation assisting device executes comprising a processor that executes a program, and a storage device that stores the program, wherein
the creation assisting device can access a database that stores a set of relational knowledge data including two nodes defining knowledge, and an edge that defines a relationship between the two nodes, and links the two nodes, and
the processor executes:
an acquisition process of acquiring an inference route that defines an order of a plurality of pieces of knowledge that form a hypothesis;
an updating process of updating a scenario that embodies the hypothesis in a case that a second node corresponding to a first node in an inference route acquired in the acquisition process is added to the scenario;
a generation process of generating a first search query for searching for a second destination node from the second node, on a basis of the first node in the inference route, a first destination node from the first node, and a first edge that links the first node, and the first destination node;
a search process of searching the database for particular first relational knowledge data corresponding to the first search query generated in the generation process; and
an output process of outputting the particular first relational knowledge data found through the search in the search process.

15. A non-transitory computer readable medium by a processor which can access a database that stores a set of relational knowledge data including two nodes defining knowledge, and an edge that defines a relationship between the two nodes, and links the two nodes, the recording medium having stored thereon a creation assisting program for controlling the processor to execute the procedures of:
an acquisition process of acquiring an inference route that defines an order of a plurality of pieces of knowledge that form a hypothesis;
an updating process of updating a scenario that embodies the hypothesis in a case that a second node corresponding to a first node in an inference route acquired in the acquisition process is added to the scenario;
a generation process of generating a first search query for searching for a second destination node from the second node, on a basis of the first node in the inference route, a first destination node from the first node, and a first edge that links the first node, and the first destination node;
a search process of searching the database for particular first relational knowledge data corresponding to the first search query generated in the generation process; and
an output process of outputting the particular first relational knowledge data found through the search in the search process.
